(19) United States
(12) Patent Application Publication
(10) Pub. No.: US 2009/0144363 A1
(43) Pub. Date: Jun. 4, 2009

(54) SYSTEM AND METHOD FOR REGISTRATION OF VALUABLE ITEMS

(75) Inventor: Michael F. Osterer, Elmsford, NY (US)

Correspondence Address: DARBY & DARBY P.C., P.O. BOX 770, Church Street Station, New York, NY, 10008-0770, US

(73) Assignee: U-E Systems, Inc., Elmsford, NY (US)

(21) Appl. No.: 12/368,280

(22) Filed: Feb. 9, 2009

Related U.S. Application Data
(62) Division of application No. 10/941,299, filed on Sep. 15, 2004.
(60) Provisional application No. 60/549,263, filed on Mar. 1, 2004.

(51) Int. Cl. G06F 15/16

(52) U.S. Cl. 709/203

(57) ABSTRACT

A system and method are provided for keeping track of the ownership of unique items in a system including a server computer connected to a database and at least one client computer connected to the server computer over a network. In operation information concerning the item is entered into the client computer. This information, includes at least a description of the item and its owner, is uploaded from the client computer to said server computer where the information is stored in the database. In response, the system provides from the server to the client computer a transaction identification number related to the information and an item number related to the item. A user at the client computer can use the transaction identification number to access the uploaded information at the database to determine the current owner of the item. Upon a transfer of ownership, the new owner can use at least one client computer to enter the transaction identification number and new owner information to update the information in the database to indicate the new owner and to indicate the prior owner as a seller of the item. In response a new transaction identification number is provided from the server computer to the client computer.

### CROSS-REFERENCE TO RELATED APPLICATIONS

This application claims priority to U.S. provisional patent application No. 60/549,263, filed Mar. 1, 2004 which is incorporated herein by reference in its entirety.

### BACKGROUND OF THE INVENTION

1. Field of the Invention

The present invention relates to a system and method for tracking the ownership of valuable items to enhance the value and the possibility sale of such items, particularly over the Internet.

2. Discussion of the Related Art

In a face-to-face transaction, the seller of a valuable item can show the item, thus confirming that the seller is in possession of the item. Furthermore, the seller can provide sales documents which show that the seller is the legitimate owner of the item. However, in remote sales, e.g., sales by telephone or over the Internet, it is difficult for the purchaser to confirm that the seller has possession of the item, let alone has legitimate title to, i.e. ownership of, the item. As a result, many people are reluctant to make online purchases of unique, i.e., one of a kind, items such as artwork or sports memorabilia. In addition, there have been cases in which unscrupulous individuals have made fraudulent sales of products over the Internet that either they did not have or obtained illegally. This has had a detrimental effect on Internet sales.

In order to overcome these problems, it has been suggested that the seller place the item with a third party who can verify its existence, and perhaps its authenticity. However, this is a time-consuming process since the item must be physically moved to the location of the third party, which can delay the sale process and involves at least some expense for transport and storage of the item. Further, the third party may have to employ experts to check the authenticity of the item, also a time-consuming effort, which is subject to its own uncertainties. Further, authentication can be a significant expense.

Thus, it would be desirable if a system and method could be provided that could at least enhance the purchaser's confidence that the seller has a legitimate item for sale, without the drawbacks of loss of significant time and greatly added expense.

### SUMMARY OF THE INVENTION

The present invention is directed to a system and method for enhancing remote sales of valuable, one of a kind items by registering for a fee with a registry company at least one legitimate transaction in the item. More specifically, the present invention relates to a system and method whereby a transfer of ownership of a valuable item, e.g., artwork or sports memorabilia, is recorded by registering the sale from a eputable source, e.g., an art gallery. Subsequent transfers are also registered creating a chain of ownership or provenance. The registration information is made available for a fee over the Internet to prospective buyers. Thus, when a remote sale is to take place, e.g., over the Internet, or title to the item is in question, the potential purchaser can confirm that the seller is the most recent in the chain of title to the item.

This system gives the owner the ability to demonstrate remotely a high probability that he legitimately owns the valuable item in his possession. Optionally, the registry company may give subsequent purchasers the ability to update the registration for a fee at each subsequent transaction, i.e., to register and enter their ownership information. As an additional alternative, the registry company can be operated so as to charge an additional fee annually to renew and maintain the registered information even if there is no subsequent transaction. The current and past ownership information concerning the item can be made available over the Internet at a website for a fee with the consent of the current and/or past owners.

It is preferable to require verification of the true identity of the purchaser is required. This may be done by ensuring that the name of the buyer matches several forms of identification. This will additionally enhance and add value to the database of registration information by having true identity of the purchaser on file. A certificate of title may be withheld from the purchaser until the identifying process is complete. If this process and procedure cannot be satisfactorily completed, the selling agent (e.g., a gallery) may be contacted by the registry company in order to obtain additional information about the true owner. Efforts can be made by the registry company to obtain secure verification of the persons identity as quickly as possible so that the issuing of the certificate of title is not prolonged.

Verification of the true identity of the purchaser is performed for each purchaser, whether original or subsequent to keep the chair of authenticity.

Additionally, the system allow current owners to request a certificate of title and register existing collectibles and unique items into their portfolio. This type of registration would be notated as originating from the registrant without verifiable data from a sales affiliate. However, should appraisal information from a reputable source be available for the collectible or unique item, this information would be entered into the registrant's portfolio. This would assist the registrant in keeping updated appraisal records thereby providing valuable data utilized by insurance companies in the even of a loss. Additionally, this verifiable appraisal information would enhance the registrant's ability to obtain a fair price if they were to sell the unique item individually or through the services of the registry company.

In accordance with a presently preferred exemplary embodiment of the present invention, a gallery or store can register a valuable item online with a website upon the sale of the item. The registration would include the date of the transaction, the names and addresses of the buyer and seller, as well as a description and possibly a digital electronic image of the item. The website could charge a fee for this service. In response to the registration, the website could preferably provide a transaction identification and account number.

When the gallery or store sells the item to a purchaser, it can include the original registration cost in the purchase price and provide the registration information to that purchaser at the time of sale. The purchaser can then update the registration for a fee or as an included service by contacting the website. This update would indicate the new purchaser's information and the date of purchase. Since less information is involved, this registration could be for a lower fee than the original or the fee could be charged only upon a second transfer of ownership from the first purchaser to the second. The transaction identification number and an item number from the original transaction can be used to assure that the change in registration or ownership is from a legitimate owner traceable to the original gallery or artist. In response to the update, preferably a new transaction number is issued by the website or the original number follows the item having the owner information securely verified and updated. At this point a new or original certificate of title would be issued. Use of transaction numbers assures that the original gallery or store, which no longer owns the item, as well as some third party attempting to perpetrate a fraud, cannot improperly change the registration. The item number would typically remain constant throughout all subsequent transactions. However, it the item were changed in some way, e.g., if an autograph is provided on an original baseball, a new item number may be assigned. The item number would also be part of the purchasers portfolio which is accessible only after their log in identification and personal password are entered. The collectible and its identifying number would correspond with the owner and their portfolio.

A fee is paid to the website at each update of the registration or new transaction and/or, at the option of the registry operator, annually to maintain the registration. By agreement, a portion of the fee can be remitted to those professionals in the art market involved in making the original registration. Where the initial registration is made by the item's creator, e.g. an artist, or a sports figure who has autographed memorabilia, that person essentially gets a residual payment on subsequent transactions as long as registration has not lapsed. Further, by agreement, the original registrant can be notified of a subsequent sale of the item. For a fee, the website will provide information about the new owner to the original registrant for marketing purposes, assuming permission was granted by the new owner at the time of the update and/or registration. In addition, the registry company may optionally contact a new owner on behalf of the original registrant. It is also possible to provide a list of all of the sales transactions pertaining to a specific item, perhaps excluding prices, so potential purchasers can view the provenance of the piece. This may be done by permission, or it may be a requirement of registration. An identification or account number may be used where the true owner wishes to remain anonymous; however, in that circumstance, the registry would know the true owner and would verify the transaction involving the identification or account number of the owner.

Further, if a potential purchaser of the item wants confirmation that the seller is a legitimate holder of the item, the seller can provide a unique identifier number issued by the website for a fee. This ancillary number will permit the potential purchaser to access the website for free or for a nominal amount to confirm the transaction records, but will not allow any change in the registration. Thus, a purchaser can be made to feel comfortable about purchasing a one of a kind, unique item over the Internet, e.g., on eBay®, because he can be assured that the seller is in the chain of ownership from a legitimate first source, such as an artist, a gallery or a recognized store.

The invention does not require the physical movement of the item or its authentication in order to provide a reasonable amount of security to the purchaser of the seller's ownership rights, which enhances the seller's ability to sell the item quickly and remotely.

### DESCRIPTION OF THE DRAWING FIGURES

These and other features, aspects, and advantages of the present invention will become better understood with reference to the following description, appended claims and the accompanying drawings wherein:

FIG. 1 is an illustrative embodiment of a system in accordance with the present invention;

FIG. 2 is a flow chart of the method in accordance with the present invention;

FIG. 3 is a screen produced by the system of FIG. 1 for registration or the update of the registration of an item; and

FIG. 4 is a screen produced by the system of FIG. 1 for displaying the chain of ownership of an item according to the present invention.

### DETAILED DESCRIPTION OF THE PRESENTLY PREFERRED EXEMPLARY EMBODIMENTS

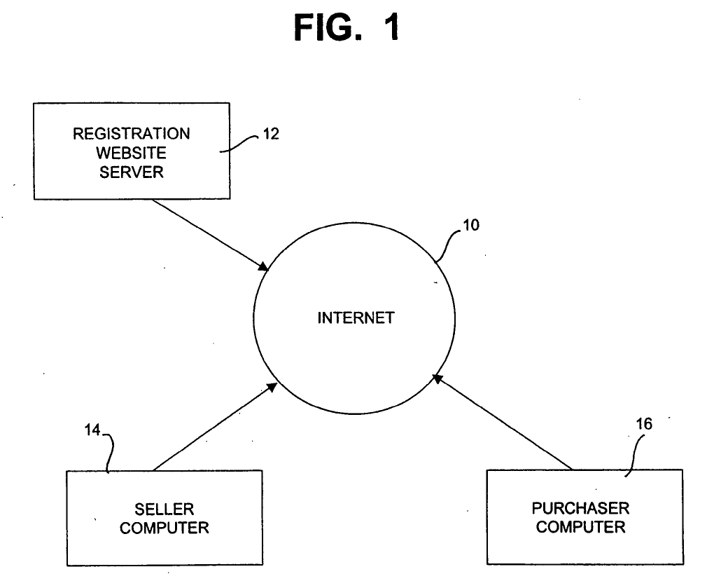

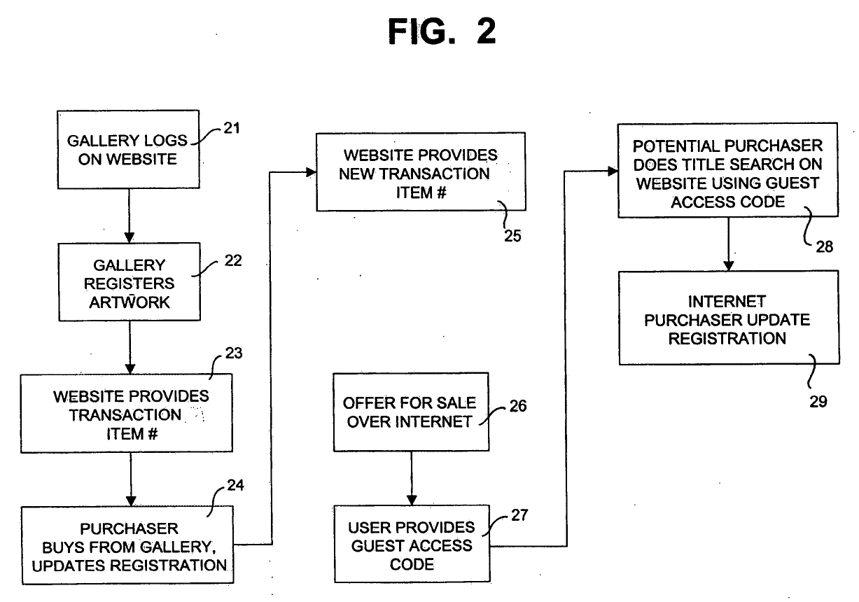

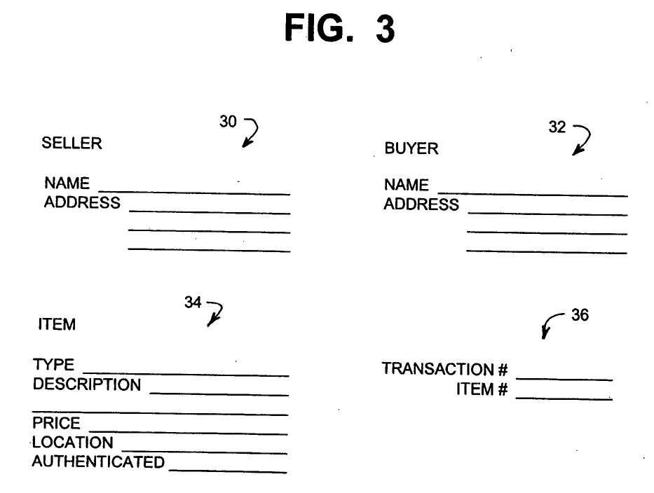

Referring to FIG. 1 there is shown a traditional client server configuration using the Internet for connecting the computers. A registration website server 12, which is operated by a registry company, has a database and runs application software for carrying out at least some of the aspects of the method set forth in FIG. 2. Assuming that the seller is an art gallery that has acquired a work of art using its computer 14, a modem and an internet service provider, the gallery logs onto the website server 12 through the Internet 10 (Step 21). At a typical welcome screen, the system may collect a registration fee by electronic fund transfer, credit card, pre-established account or some other means known in the art. Then the gallery is permitted to navigate to the registration screen provided at computer 14 by the server 12 as shown in FIG. 3. Here the gallery registers the work (Step 22) by entering the name and address of the artist in the seller fields 30. It puts its own name and address in the buyer fields 32 or it leaves the buyer field empty and places a pending order for a certificate of title on particular collectibles. It will be noted that the origination source (i.e., the gallery or artist) has placed this order for certificates of title on certain or all of their collectibles. After the transaction of purchase occurs the “buyer” field would be completed with the name of the buyer. The fields 34 are then used to register information about the item, e.g., the type (painting), description, purchase price, location of the item at the time, and optionally, whether the gallery or a third party has appraised or authenticated the artwork. The gallery may also insert or upload one or more electronic images of the item into the record as an additional means of identifying the item. The gallery is presumed to be a legitimate source and capable of authenticating the artwork.

The server 12 of the registry company with its database is thus the location which registers the name and all of the pertinent information related to the art in the seller's and purchaser's names. The server then provides a randomly generated transaction number back to the gallery, along with a similarly generated, but different account number. (Step 23) This is done by populating fields 36 of FIG. 3.

When the gallery sells the artwork to a customer, e.g., Mr. Jones, the gallery can include the cost of registration in the purchase price. The registration information (including item number and transaction number) would be provided to Mr. Jones along with the artwork. For Mr. Jones to receive the Certificate of Title to the piece he has just purchased, Mr. Jones needs to enter the pertinent information into the system, e.g. at a website, which permits him to choose a log in name and password. At this point the registry company would verify/validate the identity of Mr. Jones using multiple sources, thereby ensuring that the person accessing the system via the website is actually Mr. Jones. Once this process is complete, Mr. Jones would receive a Certificate of Title detailing information about the collectible, the registration number(s) and the owners name (Mr. Jones) on the certificate. The database would reflect this information in addition to any other data that is to be included in the portfolio of Mr. Jones relating to this item. In order to enhance his ability to make a subsequent sale of the artwork, Mr. Jones would update the registration information to show that he is now the owner. He does this by logging on to the website of the registry company from his computer 16. At the welcome screen, Mr. Jones would pay an update fee and enter the transaction code provided by the gallery. This takes Mr. Jones to a registration screen (Step 24) that looks similar to FIG. 3, except that the seller information would have been previously filled in by the registry, since it is the buyer information under the original item and transaction number. Mr. Jones is required to insert the new buyer information, i.e., information about him. Also, the description of the item would have been previously filled in by the registry system. In a preferred embodiment, the new purchaser is not able to change the seller and item information. All he can do is enter his name, address, and other required information, and perhaps change the information about the location of the item. The system would then automatically generate a new transaction number under the existing item number. (Step 25).

While not required, in a preferred embodiment of the invention, the registry company could notify the purchaser annually and request a fee for renewal or continuation of the registration. If the provenance (chain of title/ownership) began with the artist, it is imperative that the initial owner of the artwork and all subsequent owners maintain the registration so that there is never a doubt that the chain of ownership remains unbroken from the artist to the current owner. Moreover, the piece retains its value as well as providing a continued distribution (royalty) to the artist.

In addition, there could be multi-year options that would further reduce the cost of renewal and renewals could be by specific collectible or bulk portfolio pricing. Additionally, by keeping their registration active registrants will benefit from other features of the website, such as notice (at the artist's discretion) of new pieces by that artist that are for sale, the opportunity to buy or sell through the website, informative articles of interest to collectors, notice of auctions, art shows, etc. Therefore, it is highly likely that those who have purchased valued collectibles would want to keep them registered.

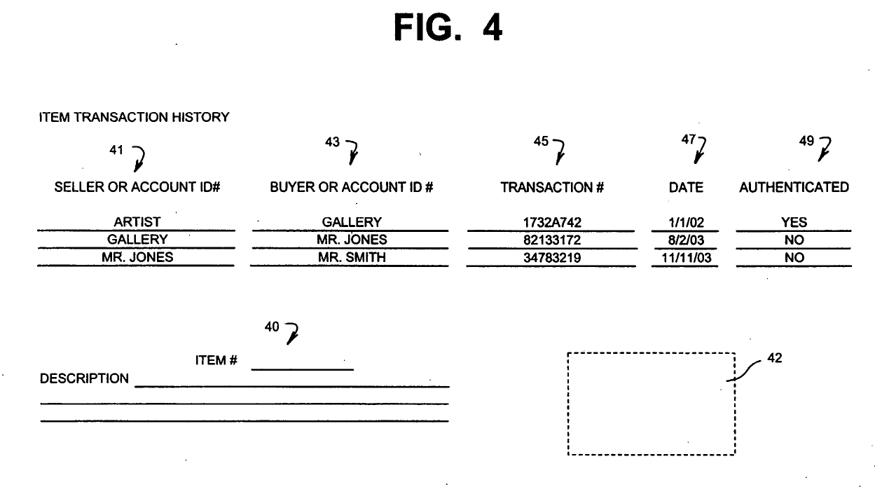

The process of selling the item and updating and renewing the registration may continue indefinitely. However, assuming in Step 26 that an owner wants to sell the artwork over the Internet or in some other transaction that is not face-to-face, the seller may then provide a guest access code to all potential purchasers (Step 27). As an example, the guest access code can be made a part of the description of the item on an Internet auction site such as eBay®. Purchasers interested in the artwork could then log on to the server 12. At the welcome page, instead of clicking on the button to register or update a registration of a work, the potential purchaser may click on the title search button. For free or for a nominal amount collected in the usual way, the potential purchaser may put in the guest access code. (Step 28) At that point, the potential purchaser is presented with the history of the transactions as shown in FIG. 4.

As can be seen, FIG. 4 presents an identification (names and/or i.d. numbers) of buyers and sellers (41,43), the relevant transaction numbers 45, the dates of transactions 47 (i.e., the purchases and sales) and any third party authentication or appraisal information 49. In addition, the page may provide a description of the item 40 and optionally a digital electronic image of the item 42.

The transaction history of FIG. 4 shows the artist selling the artwork to the gallery and the fact that the gallery authenticated it. It also shows the gallery selling the work to Mr. Jones (and/or his identification number), and the fact that Mr. Jones did not authenticate it. Further, it shows the sale to Mr. Smith (and/or his identification number) by Mr. Jones. Notice that the sales price is not listed. However, the sales price and/or an appraised price could also be listed by agreement of the parties. For example a gallery or an expert engaged by the gallery could appraise the item, and this information could be included in a registration created by the gallery.

If Mr. Smith is the person posting the artwork for sale over the Internet, potential purchasers can see that it was once authenticated and/or appraised, and there is an unbroken chain of title from the artist to Mr. Smith. Thus, the potential purchaser will have an enhanced degree of confidence that he is purchasing a legitimate piece of artwork from its lawful owner. Further, a potential purchaser can view an image 40 of the item and compare it to one being offered over the Internet.

If the work is purchased over the Internet, the purchaser can be provided with the current transaction number so he can update the registration and make his subsequent sale easier.

As noted, at each registration, renewal, update and search, the website can generate revenue. By agreement, the original seller (artist, gallery, wholesaler)—if applicable—can be credited with a royalty payment each time an annual or multi-year registration renewal occurs and each time a registered item is resold and updated. This will be administered by the registry company. Further, the registry company can generate revenue from advertising placed on the website.

In addition, upon registration, renewal or update, the customer can be asked if he would like to receive information about similar items. If the customer chooses to receive such information, the artist, gallery or prior owners may be allowed to provide it (either through the website or directly to a customer) upon payment of a fee to the website. Presumably, someone purchasing the item would be a good candidate for the purchase of additional work by the same artist or from the same gallery. The new registrant would be asked whether he or she wishes to receive information about new work from the same artist, about shows including work by the artist or at the gallery from which they purchased the registered item, or about other similar events. The registrant could also be asked whether he wants his contact information made available to the artist or gallery to include in a list of collectors of the artist's work for public relations or for other marketing purposes. Otherwise, the registrant can choose to remain anonymous or to be identified only by a numeric code or pseudonym, so that contact for promotional purposes, if any, must be made through the registry company.

While not required, preferably the system can notify the artist or the gallery that a transaction has occurred, and for a fee provide them information about the transaction or send information to the participants in the transaction about art available from the same gallery or artist.

As noted above, but as an incentive to initial registration, the system can provide a portion of the fees collected back to the original registrant or other participants in the initial transaction, especially if it is the artist or gallery. This is a form of residual for the artist or gallery that allows income to continue to be generated after the initial sale, and optionally tracks the location of the work long after the initial transaction. An additional incentive to initial registration or registration prior to sale of the item is that registration provides security, enhanced value and a competitive advantage over unregistered work. Further, the registration fee and any renewal fees incurred by seller can be passed on to the purchaser as part of the purchase price.

In addition to works of art, other unique items can also be registered, e.g., sports memorabilia, fine wines, rare books, coins, stamps, other collectibles, etc. While common items could also be registered, it is not anticipated that there would be much interest in registering such items, since there is much less motivation for the creation of unauthorized duplicates of such items.

The chain of ownership provided by the present invention can become the underpinning for a new industry which pays residuals to artists and galleries or other participants in the initial transaction, provides a far greater sense of security to the purchaser, and enables the artist and the artwork to command more bidders and higher prices. Additional highly desired and unique attributes of the process are as follows:
A. If the artwork is up for bid on a website such as eBay® and there are a large number of prospective bidders, these bidders can go to the website to review the history of the item without contacting or disturbing the seller. In addition, the seller's anonymity can be maintained.
B. From the artist's point of view, when the artist sells his artwork to his customer, the artist knows only the original purchaser. After the artwork is sold by the original customer to another, the artist may no longer knows who is in possession of his artwork. With the present invention, an artist will be able to determine the current ownership and/or the history of ownership (provenance) of his artwork, even if it has been sold many times over, providing that it is registered each time it is sold. This feature is invaluable to the artist. It makes it possible for the artist to contact, through the registry for a fee, all those people who have purchased his artwork to notify them of any new creations.
C. Residual royalties are paid each time a TV program is shown; a royalty is paid each time an advertisement is shown; composers receive a royalty each time their music is played. Now, for the first time, a provenance database that traces an item's chain of title/ownership can be used to provide a venue for royalty payment to the artist every time his art is resold, providing it is registered. This was not possible before the introduction of the personal computer and a registration process according to the present invention. Thus, it is now possible for an artist to be on equal footing with a songwriter, author, actor, etc.
D. In one embodiment, the operation of the system can be viewed as having dual purposes. The registry company acts as the depository for all the data for all types of registered items. The present invention also can be valuable to an insurance company as part of its appraisal process. Use of the present invention can greatly reduce the expenses of an insurance company in reappraising any item that has been previously appraised. This reappraisal information can be noted as such on the registry. Additionally, if there is a disaster such as a fire, and the insured item is destroyed along with the backup paperwork, the insurance company and/or the owner can obtain the relevant information from the registry company so as to establish that the item was purchased at a particular time and place from the seller. Also, a digital image of the item may be available from the registry.

Artists everywhere in the world, as well as buyers, gallery owners, auctioneers and insurance companies would benefit greatly from this process. This methodology instills a far greater value in what is being purchased, thereby supporting higher prices and underpinning the industry.

For exemplary purposes only, assume that a piece of art is purchased for $1,000.00 Included in that price, is the cost of the registration in the purchaser's name, which was sold for $24.95 to the artist and dealer. (Individual purchasers could be charged more). From the $24.95 fee, $5.00 could be credited to the artist and possibly $3.00 to the gallery. This would be handled by the accounting software operated by the registry company.

In one embodiment the registration fee is charged only once and update fees are charged only upon a change of ownership. However, as an alternative, a charge could be made each year (e.g., a fee of $7.95) for keeping track of the artwork registered. Two dollars of this renewal fee could be credited to the artist's account (royalty) and $2.00 could go the gallery account. The gallery could continue to be considered the salesperson. This would leave $3.95 for the registry company. Five years later, the artist and the gallery each would have received an additional $10.00 in credit from the sale of that one painting. As an additional source of revenue the registry company can take a minimum fee for administration or a percentage (10 to 15%) of the transaction—whichever is higher.

In a further embodiment, an initial registrant has the option upon registration to provide information about the buyer of the registered item or just about the item itself. The initial registrant is often a seller, and often a professional seller, such as an art gallery. If the initial registrant has chosen to provide the registry company with information about the buyer of the registered item, such information may include, but is not limited to, the buyer's name, mailing and email addresses. Information about the item could include an electronic image of the item, e.g., a numbered laser photo), the purchase price of the item, and an appraisal of the authenticity and value of the item.

If the initial registrant provides this information, the registry company may offer some or all of this information on its website. Furthermore, the registry company may contact the buyer to request a yearly renewal payment and may send to the buyer other information that may be deemed of interest, such as notices of special events, sales and auctions. If the buyer makes the yearly renewal payments, the registration is kept current, and portions of the yearly payments are remitted to the artist (i.e., the creator of the item), the initial registrant (i.e., the gallery) and other participants in the initial transaction. If the item is resold, the artist and initial participants may continue to receive portions of the fee charged for registration of the new sale, if the item is registered by the new owner.

In order to avoid inadvertent loss of registration, the registry company may offer multi-year registration contracts, registration insurance, or the ability for an owner to pay the registration fees of previous lapsed years in order to revive an expired registration. Prior to a sale, the current owner whose registration has lapsed may pay a one-time reinstatement fee in addition to paying the fees for lapsed years to maintain a continuous chain of title. However if a sale occurs prior to reinstatement, the provenance will begin anew with the sale and registration by the new buyer.

If the initial registrant chooses not to provide any information about the buyer, the buyer cannot be reached to keep the registration current. Thus, the registration will expire. If the buyer sells the item again, the seller or new buyer may register the new sale, however the chain of ownership will not be maintained and it must begin anew with the later transaction.

In a further embodiment of the invention, a portion of all registration and yearly renewal fees is paid to a non-profit organization dedicated to assisting artists in need. This is a further benefit to the artistic community. This non-profit organization would be separate from the registry company with its own name and distinct board of directors who manage the fund that is specifically created from a percentage of all registration and renewal fees. For the first year, an ad hoc board could oversee management of the fund. These board members could then be replaced by professional and nonprofessional managers.

An example of a strategy for distribution of funds from the operation of the registration where charities are involved is as follows:

| Participant | Percentage |
|---|---|
| Registration Company | 50.00% |
| Artist/Creater | 10.00% |
| Wholesaler/Agent | 7.50% |
| Gallery | 10.00% |
| Auctioneer | 10.00% |
| External Organization | 5.00% |
| Attorney for Artist | 5.00% |
| Artist's Fund | 2.50% |
| TOTAL | 100.00% |

An External Organization could include a charitable group not specifically related to artist, and promoters of artistic events. If one or more of the participants listed in the table besides the Registration Company do not actually participate in the registration process, the remaining participants can receive 50% of the proceeds on a prorata basis. The sums can be either the gross or net receipts after the deduction of operating expenses.

Having described the presently preferred exemplary embodiments of a system and method for registration of valuable items in accordance with the present invention, it is believed that other modifications, variations and changes will be suggested to those skilled in the art in view of the teachings set forth herein. It is, therefore, to be understood that all such modifications, variations, and changes are believed to fall within the scope of the present invention as defined by the appended claims.

1-31. (canceled)

32. A method for keeping track of the ownership of unique items in a system including a server computer connected to a database and at least one client computer connected to the server computer over a network, comprising the steps of:
receiving at the server computer, information entered at the client computer concerning the item, said information including at least a description of the item and the identity of its owner;
storing the received item identification information in the database to create a record of the origination of the item which is utilized once the item is purchased
providing from the server computer to the client computer a transaction identification number related to the registration and an item number related to the item registered;
in response to receipt at the server computer of an access request and the transaction identification number, providing to access by the at least one client computer to the registration information at the database in order to permit a remote determination of the current ownership of the item;
in response to receipt at the server computer of the transaction number and information concerning a transfer of ownership, including the identity of the subsequent owner; updating the registration information in the database to indicate the new owner and to indicate the prior owner as a seller of the item; and
providing from the server computer to the client computer a new transaction identification number in response to the updating of the registration information.
